(19) United States
(12) Patent Application Publication
(10) Pub. No.: US 2005/0163563 A1
(43) Pub. Date: Jul. 28, 2005

(54) Device for joining two components particularly tubular ones

(76) Inventor: Francois Joncourt, Wabern (CH)

Correspondence Address: YOUNG & THOMPSON, 745 SOUTH 23RD STREET, 2ND FLOOR, ARLINGTON, VA, 22202, US

(21) Appl. No.: 10/870,947

(22) Filed: Jun. 21, 2004

(30) Foreign Application Priority Data
Jun. 19, 2003 (CH) 2003 1072/03

(51) Int. Cl. F16L 35/00

(52) U.S. Cl. 403/373

(57) ABSTRACT

The device (10) for joining, particularly two tubular components (1, 2), one male, one female, is made up of the first means (11) which make it possible to join two components with each other in rotation and the second means (15) which make it possible to join said components in translation. The first means (11) have a slot (12, 13) made in the component (1) and a stopping means (14) arranged in the component (2). The second means (15) are made up of a system of at least one strap (20) connected to the component (2) and at least one buckle (16) connected to the element (1).

The present invention relates to a device for mechanically joining or assembling two components, especially two tubular ones, with each other according to the introduction to the independent claim 1.

These devices are applicable in diverse fields. It is possible to cite, inter alia, quick assembly of umbrellas, maisonettes of a tubular structure, camping tents, stretchers, wheels used in carrying loads during hiking, etc.

On the market there are various devices of this type, in particular those used for joining two tubular components (with a circular base or any shape). It is possible to mention, as an example, in addition to the standard screw-nut system, the device for blocking, in translation and in rotation, a male tube and a female tube intended to be fitted in each other, this device consisting of a ball placed in the tubular envelope of the male component and subjected to the action of an elastic unit, a cap defined by this ball which an be clipped into an opening of a diameter adjusted and made in the female tube. Fitting is simple and quick as it suffices to place the male tube into the female tube until the cap of the ball comes against the rim of the female tube, then to apply a supporting force on the ball against the force of the elastic unit and to continue inserting until the ball is situated opposite to said opening, the moment when said cap is engaged in the latter under the action of the elastic unit to assure a joint between the tubes in translation as well as in rotation. Other devices have a crown with holed seizing joints, and others have also additional means made up of plastic leaves, etc.

Generally speaking it is always desirable to be able, on the one hand, to quickly and easily but reliably join or assemble two components, and on the other hand, to propose an inexpensive product. These features can be certainly fulfilled by a screw-nut system, but mounting components between them would be fairly tedious and awkward, even when additional tools are required; or the device is simple and quick, enabling easy and convenient assembly, the features which can be obviously fulfilled by a ball system such as that described above, but it is well known that the assembly so obtained suffers from mediocre and uncertain reliability. There are also other disadvantages in addition to these shortcomings during unmounting or disassembly of said components, as these operations can prove difficult and even results in the destruction of the assembling device, due to corrosive effects caused by time or the environment (rust, seizure caused by sand or mud, etc.).

The aim of the present invention is to achieve a mechanical joining device which is not affected by the disadvantages described above.

The aim is achieved by using the means defined in the characterising part of claims 1, and the means defined in the dependent claims which make it possible to implement the invention easily and in accordance with preferred constructions.

The claimed device makes it possible to mount and unmount components in a quick, easy, efficient and reliable manner regardless of the weather conditions. It is also lightweight, compact and does not change its shape. Finally it does not require maintenance and can be very easily produced.

A form of embodiment will be now described as an non-limiting example with reference to the accompanying drawings in which:

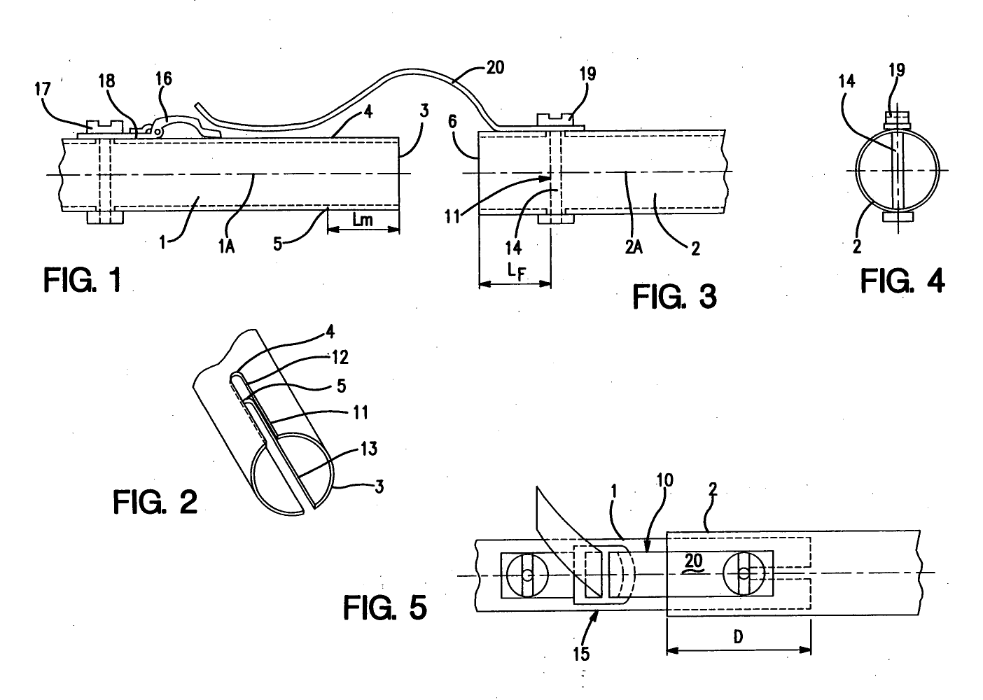

FIG. 1 is a front view of a male component having part of the means of the joining device;

FIG. 2 is a perspective view showing part of the edge of this male component intended to be introduced into a female component and integrated with it;

FIG. 3 is a front view of the female component having the other part of the means of the joining device;

FIG. 4 is an end view of the female component; and

FIG. 5 shows the two components in the assembled or joined state.

It should be noted that the scales of the different figures are not uniform.

FIG. 1 shows the terminal part of the male component in the form of a tube 1 of axis 1A, provided with part of the first means (11) of the joining device (10). This tube has, as shown more clearly in FIG. 2, two identical notches or grooves, an upper one 12 and a lower one 13. These notches are obstructed, or in other words, they are made on a defined length Lₘ from an external edge 3 on which they open. The rear ends 4, 5 of the grooves 12, 13 are preferably rounded so as to correspond to the diameter of a stopping means 14 (FIG. 3) which will be described later. The central plane (not shown) of these grooves 12, 13 is a radial plane passing through the axis 1A.

FIG. 3 shows the terminal part of a female component in the form of a tube 2 of axis 2A, particularly provided with the other part of the first means (11) of the joining devices (10). This terminal part has said stopping means 14 which plays the role of a stop. This can be in the form of, for example, a radial rod 14 whose ends (not shown) are integral with the envelope of the tube 2. This rod is placed at a distance L_{f} from the external edge 6 of the tube 2 and passes through the axis 2A.

The external/internal diameters of the tubes 1, 2 are defined in such a manner that the tube 1 could by easily introduced, preferably with a very small gap, into the tube 2, until the ends 4, 5 of the grooves of the tube 1 come against the rod 14. It should be noted that the tube 1 then extends into the tube 2 on a distance D (FIG. 5), which is a function of the magnitudes Lₘ and L_{f} and can be freely determined by the manufacturer in accordance with specific criteria (for example stiffness).

The set of elements: the grooves 12, 13 and the stop 14 thus form the first means 11 of the joining device and make it possible to limit the introduction of the tube 1 on said defined distance D and assure the joining in rotation of the tubes 1, 2 with each other.

The joining device also has second means 15 which, after the introduction of the tubes 1, 2 into each other, make it possible to join them with each other in translation in the form just described to achieve blocking.

Advantageously, these second means are made up of a linking system consisting of a strap interacting with at least one buckle. According to a form of embodiment, they consist of a flexible strap 20 on the tube 2 and fixed to it by means of a screw-nut system 20. According to the form of embodiment described, the rod of the screw-nut system 20 (namely of the screw (not shown)) plays at the same time the role of a stop 14. FIG. 4, viewed in the direction of the axis 2A of the tube 2, allows the radial arrangement of these elements 20, 14 to be seen. The second means comprise, on the other hand, on the tube 1, a buckle 16 of the known auto-blocking type (shown in a highly simplified or symbolic manner in FIGS. 1 and 5 (on the latter the buckle is shown by a single cross-bar)) fixed to it by means of a screw-nut system 17 through a soft strand 18 of a determined length, preferably fairly short, for example in the order of a few centimetres in order to make handling easy. When the two tubes 1, 2 are in place, namely introduced into each other, it suffices to introduce the strap 20 into the buckle 16 and to continue to block. The tubes 1, 2 are then completely immobilised in relation to each other. The two tubes are thus easily and quickly disconnected by handling the means for blocking in translation, that is, in this example, the strap 20 and the buckle 16. In an alternative version, in order to assure better security in joining in translation, a second set of strap/buckle 16/20 may be provided, diametrically arranged opposite to the set 16/20 shown in the figures and described earlier.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A device for joining two components, one male, and one female, one fitted into the other over a distance, the female component being hollow or tubular at least on said distance, these components being provided with means for joining in their fitting zone, characterised in that on the one hand and in the first time, the first means make it possible to limit and assure, respectively, the fitting on said distance and the joining in rotation of the two components, these first means being made up of stopping means arranged on one of the components and interacting with a corresponding means provided on the other component, and that, on the other hand, the second means make it possible to assure, in the second time, the joining in translation of said components.

2. A device as claimed in claim 1, characterised in that the stopping means is made up of a rod with the female component and crossing right through it, orthogonally to its axis and on a length defined by its end, and that the corresponding means results from an obstructed notch made in the male component on a length defined by its end and along a central plane passing through said male component.

3. A joining device as claimed in claim 1, characterised in that the second means are made up of a linking system consisting of at least one strap interacting each time with or at least one buckle.

4. A joining device as claimed claim 3, characterised in that the linking system has, on the one hand, a strap connected to the female component by a holding means and on the other hand, a buckle connected to the male component by a holding means, preferably through a soft strand.

5. A joining device as claimed in claim 4, characterised in that the holding means integrating the strap with the female component also plays the role of a stopping means.

6. A joining device as claimed in claim 2, characterised in that the second means are made up of a linking system consisting of at least one strap interacting each time with or at least one buckle.
